(19) United States
(12) Patent Application Publication
(10) Pub. No.: US 2003/0103182 A1
(43) Pub. Date: Jun. 5, 2003

(54) Vertically aligned liquid crystal imaging component with compensation layer

(75) Inventors: Xiang-Dong Mi, Rochester, NY (US); Tomohiro Ishikawa, Rochester, NY (US)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 10/020,543

(22) Filed: Nov. 30, 2001

(51) Int. Cl. G02F 1/1337

(52) U.S. Cl. 349/130

(57) ABSTRACT

Disclosed is an imaging component comprising a vertically aligned nematic liquid crystal cell, a polarizer, and a compensation film containing a positive birefringent material oriented with its optic axis tilted in a plane perpendicular to the liquid crystal cell face. Such components exhibit an improved viewing angle characteristic.

### FIELD OF THE INVENTION

This invention relates to an imaging component comprising a vertically aligned liquid crystal cell, a polarizer, and a compensation film containing a positive birefringent material oriented with its optic axis tilted in a plane perpendicular to the liquid crystal cell face.

### BACKGROUND OF THE INVENTION

Current rapid expansion in the liquid crystal display applications in various areas of information display is largely due to the improvement of the display quality. One of the major factors measuring the quality of such displays is the viewing angle characteristic (VAC), which describes the change in a contrast ratio from different viewing angles. It is desirable to be able to see the same image from a wide variation in viewing angles and this ability has been a shortcoming with liquid crystal display devices.

A vertically-aligned liquid crystal display offers an extremely high contrast ratio for normal incident light. FIG. 1 shows the schematics of display configurations. In the figure, x, y and z form orthogonal coordinates 10 and z is the direction normal to the cell surface. θ and φ are polar angle and azimuth angle, respectively. A voltage source 16 is attached to the liquid crystal cell 14. Two polarizers 12, 18 on both sides of the liquid crystal cell 14 forms an angle of 45° with respect to the x or y direction and their transmission axes are orthogonal to each other. By orthogonal, it is meant that they are 90° apart, +10°. In its OFF state, the birefingent molecule's optic axis 22, the direction in which light does not undergo birefringence, is almost perpendicular to the substrate 20, FIG. 2A. With an applied voltage, the optic axis 24 is tilted away from the cell normal, FIG. 2B. In the OFF state, light does not see the birefringence in the normal direction 26, giving the dark state that is close to that of orthogonally crossed polarizers. However, obliquely propagated light 28 picks up birefringent phase retardation giving light leakage. This results in a poor contrast ratio at a higher viewing angle as shown in FIG. 2C. FIG. 2C includes azimuth angles of 0, 45, 90, 135, 180, 225, 270 and 315 degrees, as represented along the circumference, and polar angles of 0, 20 and 60 degrees, as represented by the concentric circles. The outermost circle corresponds to the polar angle of 80 degrees. FIG. 2C shows an extremely limited area inside of the high 100 iso-contrast line indicating insufficient viewing angle performance.

For increasing contrast, it is necessary to decrease the light leakage in the dark state as much as possible. If a sufficiently dark state cannot be obtained in an oblique direction, as mentioned above, the display quality will be undesirably low.

Various methods to attain a higher contrast ratio at off axis incidence have been proposed. Clerc et al. suggested in U.S. Pat. No. 4,701,028 using quarter wave plates in combination with linear polarizer. Thus, for the normal incidence in the OFF state, the propagating light is circularly polarized. With the exit circular polarizer being orthogonal to the entrance one, the out coming light is extinguished. In off-axis case, the light becomes elliptically polarized with respect to the entrance polarizer. The cell thickness is adjusted so that the light after propagating through the cell obliquely is still absorbed at the exit polarizer regardless of the angle.

Takeda et al. disclosed the multi domain vertically aligned liquid crystal display in European Pat. EP 0 884 626 A2. Liquid crystal pixels are divided so that the tilt direction of liquid crystal molecule 11 in the OFF state FIG. 1 varies from pixel to pixel. By making director field more symmetric, it gives a good viewing angle characteristic. However, the process of making multi-domain adds extra cost and difficulty to display manufacturing.

The compensation film approach is another method that has been applied to improve the off-axis viewing characteristics. In its simplest scheme such as the one set forth in U.S. Pat. No. 5,039,185, a film with negative optical anisotropy 30 normal to the film surface is used to compensate the-off axis birefringence, FIG. 3A. The combination of two or more uniaxial or biaxial films gives a film with negative anisotropy its optical property represented by index ellipsoid 19. The viewing angle characteristic of this scheme is shown in FIG. 3B. In comparison to FIG. 2C, the iso-contrast line 50 has been expanded to 600 and 40° in the horizontal and vertical direction, respectively. In relative diagonal directions (45°/225°, 135°/315° in azimuth angle), it extends up to 80° giving wider area with contrast of 50. Film's optical properties and thickness are controlled by the requirement that the total phase retardation is zero in any direction of viewing. Based on a similar idea, V. Sergan et al. (V. Sergan, P. J. Bos and G. D. Sharp, SID 00 Digest, pp838-841 (2000)) used crossed plates with in-plane phase retardation in place of a negative film.

U.S. Pat. No. 5,298,199 discloses a somewhat more sophisticated application of biaxial film for compensation. In this patent, Hirose et al. suggests using biaxial film with the indices of refraction satisfing n_{z}<n_{y}<nₓ, and x, y and z corresponding to the directions given by the coordinate system 10. The addition of in-plane phase retardation (nₓ−n_{y})d, where d is a film thickness, decreases the on-axis transmission at non-zero applied voltage for OFF state. This enables one to shorten the switching time between the ON and OFF states, while out of plane negative birefringence compensates the oblique angle phase retardation.

Aminaka et al. suggested a compensation scheme by films containing liquid crystal polymers with discotic mesogen in U.S. Pat. No. 6,08,312. The discotic compound used is a negatively birefringent material. Inside of these films, the direction of mesogen continuously changes. The idea is to mimic the director field near the surface so as to compensate the asymmetrical viewing angle while voltage is being applied to the cell.

From a different perspective, Ohmuro et al. gave a combination of negative plate 30 and positive plate 27 with axis set on the normal direction of the polarizers (K. Ohmuro, S. Kataoka, T. Sasaki and Y. Koike, SID 97 Digest, pp. 845-848, U.S. Pat. No. 6,141,075), FIG. 4A. J. Chen et al., after careful examination of the above configuration, came to realize the importance of compensation of crossed polarizers (J. Chen et al., SID 98 Digest, pp.315-318, (1998)). Crossed polarizers, when viewed from an off-normal direction, are no longer orthogonal to each other and this fact leads to a leakage of light. Negative plates 30 (optical property represented by the ellipsoid 19) with its optic axis in a thickness direction together with positive plates 27 with its axis parallel to the polarizers' transmission axis gives superior performance. When it is applied to the vertically aligned cell, the contrast ratio at higher viewing angle is improved FIG. 4B compared to FIG. 3B. The contrast line 50 covers area further toward a higher polar angle. The 500 contrast line extends to ±45° and ±20° in horizontal and vertical direction, respectively.

While the above-mentioned methods have improved the viewing quality of liquid crystal displays, the overall viewing angle remains poorer than it is desirable. It is a problem to be solved to provide a compensation film for a vertically-aligned liquid crystal cell that improves the viewing angle characteristic of the display.

### SUMMARY OF THE INVENTION

The invention provides an imaging component comprising a vertically aligned nematic liquid crystal cell, a polarizer, and a compensation film containing a positive birefmgent material oriented with the optic axis tilted in a plane perpendicular to the liquid crystal cell face. The invention also provides an electronic device containing the component of the invention as well as methods for preparing the component of the invention.

The invention enables an improved viewing angle characteristic.

### BRIEF DESCRIPTION OF THE DRAWINGS

FIG. 1 is a schematic showing the operation of the vertically aligned liquid crystal cell imaging component.

FIG. 2A, 2B are cross sectional views showing schematically the OFF and ON state of FIG. 1. FIG. 2C is a viewing angle characteristic (VAC), diagram showing the viewing angle characteristic of a vertically aligned liquid crystal display without compensation film.

FIG. 3A is a schematic diagram of a prior art device with negative birefringent film. FIG. 3B shows the VAC of a vertically aligned liquid crystal display with negative birefringent film.

FIG. 4A is another schematic diagram of one of the prior art devices with negative and positive birefringent films. FIG. 4B shows the VAC of that device.

FIG. 5A, 5B and 5C are cross sectional diagrams of the configuration of one imaging component in accordance with the invention.

FIG. 6A shows a positive birefringent ellipsoid representing the constituent material for the anisotropic layer of the invention disposed on the base film. In FIG. 6B, the optic axis is shown tilted uniformly while it varies in the thickness direction in FIG. 6C. FIG. 6D is a diagram of the use of two positive birefringent layers arrangement on a base.

FIG. 7A, 7B and 7C show three examples of orientation of the compensation film having one positive birefringent layer with respect to the transmission axis of the polarizer.

FIG. 8A, 8B and 8C show three examples of orientation of compensation layers having two positive birefringent layers with different thickness, relative to the polarizer.

FIG. 9A, 9B, and 9C show the results of simulation for VAC of the display with various compensation film arrangements of the invention.

FIG. 10A through 10D illustrates embodiments of display device components according to the invention. FIG. 10E and FIG. 10F illustrate embodiments of a reflective display.

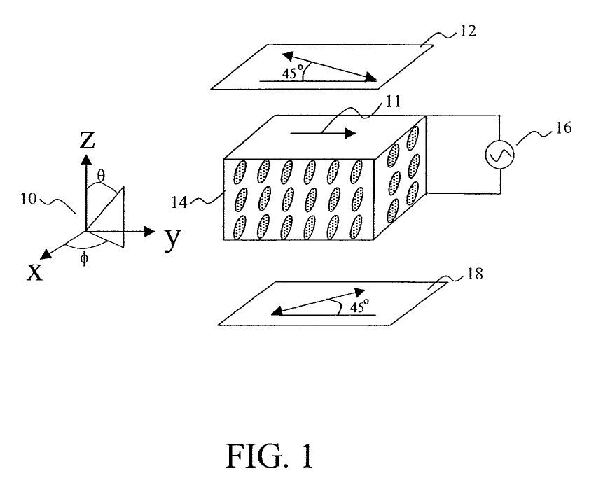

### DETAILED DESCRIPTION OF THE INVENTION

The current invention regarding the vertically aligned liquid crystal display with the optical compensation film described by referring to the drawings as follows.

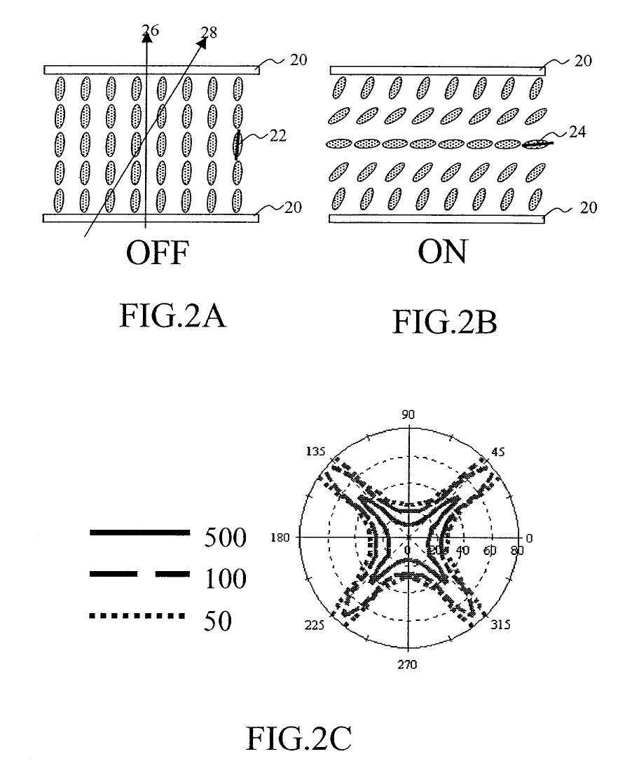

FIG. 2 is a mode of operation of a vertically aligned liquid crystal cell display in a cross sectional view. A vertically aligned liquid crystal is one in which the positive birefiingent materials are oriented in a direction normal (±10°) to the surface of the cell. When the field is OFF, FIG. 2A, the optic axis of liquid crystal molecules 22 are almost perpendicular to the cell substrate 20. With the applied field, the optic axis 24 tilts away from the normal as shown in FIG. 2B, and it gives the ON state. In the OFF state with normal viewing 26, the incoming light does not see any birefringence. If this cell is placed between the crossed polarizers, it results in a dark state. However, in the oblique direction 28, propagating light suffers birefringence, giving leakage of light. This is the source of poor contrast at the higher viewing angle as shown in FIG. 2C. It is the scope of this invention to compensate dark state of the vertically aligned liquid crystal cell to yield high contrast in extended viewing angle. In some cases, the dark state may even correspond to the one with a small field applied, in which its optic axis slightly changes from the state with a zero field. The compensation is achieved by combining a compensation film containing a positive birefingent material oriented with the optic axis tilted in a plane perpendicular to the liquid crystal cell face with a liquid crystal cell. Due to this feature, the current invention can compensate the dark state with or without applied fields.

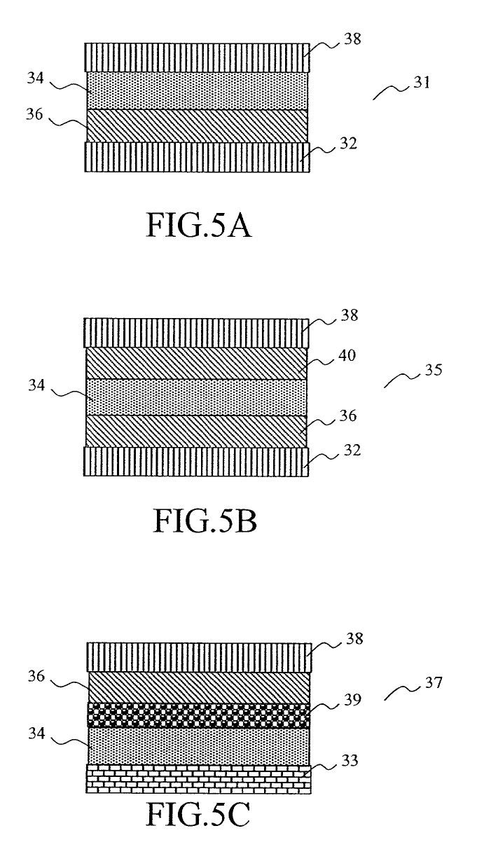

In FIG. 5, three possible configurations of the display according to the invention are shown. FIG. 5A has one optical compensation film 36 inserted between polarizer 32 and liquid crystal cell 34 while FIG. 5B has an additional compensation film 40 between the liquid crystal cell 34 and polarizer 38. FIG. 5C is a scheme for reflective type display. It has one compensation film 36 placed between the cell 34 and polarizer 38 and has light reflection plate 33. Also for reflection type devices, additional plate with in-plane phase retardation 39 in the direction of the tilt direction of liquid crystal molecule 11 has to be inserted.

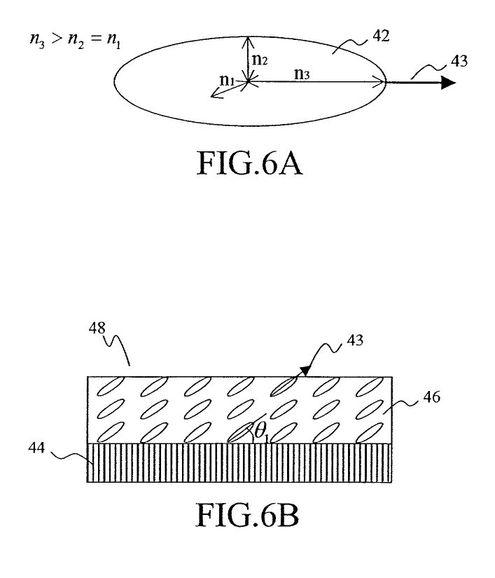

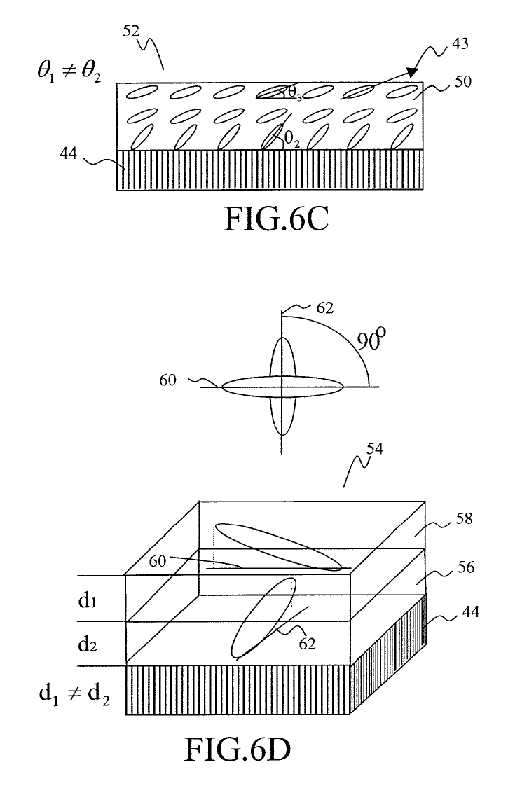

Now the actual inner structure of compensation film is described. The compensation film in accordance with this invention has more than one optically positive birefringent layers disposed on base film. The positive birefringent layers contain the material with optical property of uniaxial or biaxial nature. The direction of optic axis of the material is fixed in one azimuth angle on the film plane. In case of material with the uniaxial nature, it has positive birefringence because it has two equivalent indices n₁ and n₂ that are smaller than n₃ represented by index of ellipsoid 42 as shown in FIG. 6A. In this case, the direction of optic axis 43 corresponds to that of the maximum refraction index, n₃. In biaxial case, all of n's assume different values and the optic axis does not necessarily lie on the direction of largest n. In contrast, the discotic film, disclosed in U.S. Pat. No. 6,08,312 used as a compensation film for vertically aligned liquid crystal displays, has two equivalent indices n₁ and n₂ that are larger than n₃.

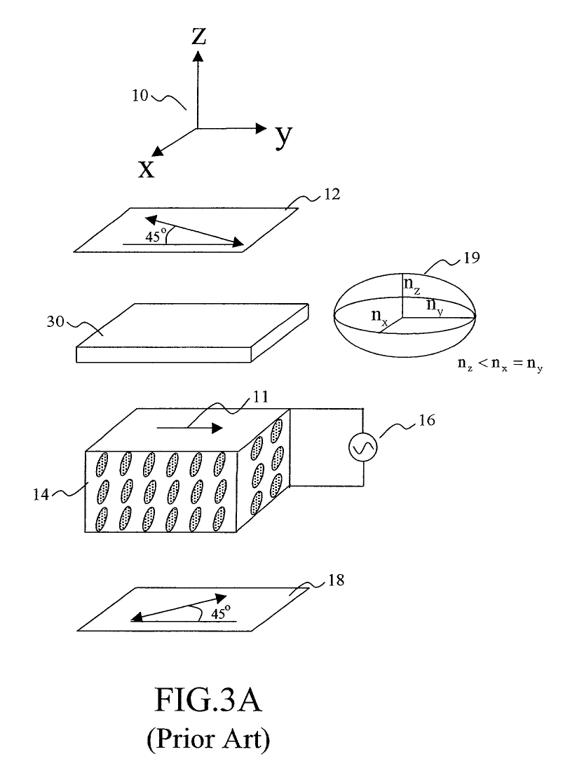

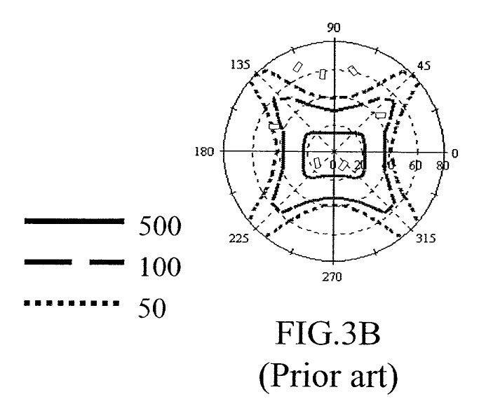

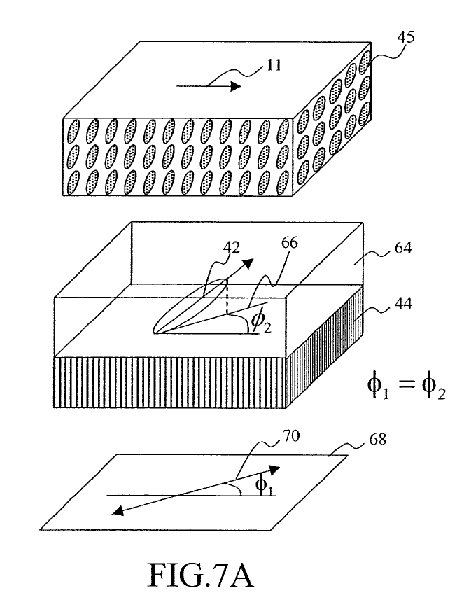

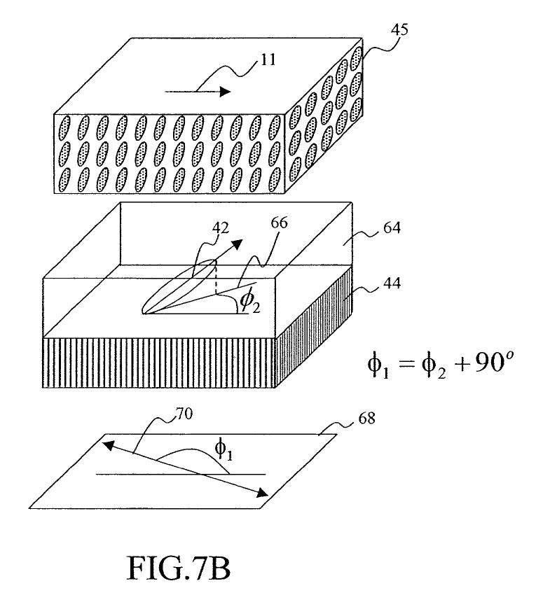

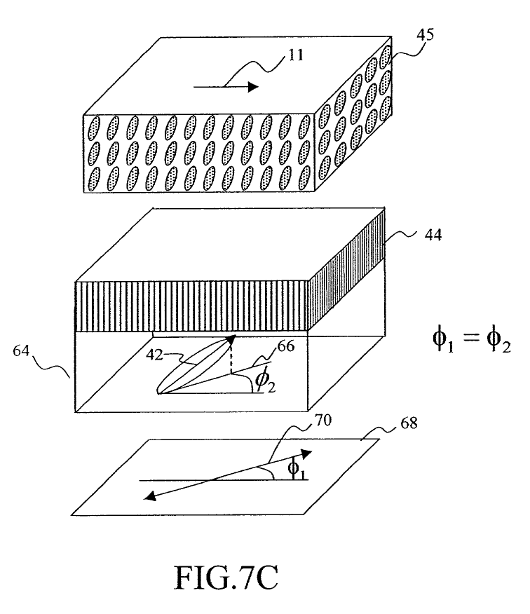

Film, exemplified by FIG. 6B and 6C has a single positive birefringent layer 46 and 50 on top of the base 44. In 6B, optic axis 43 is uniformly tilted with an angle θ₁. Further, in 6C the tilt of optic axis changes across the thickness. The angles θ₁ and θ₂ that optic axis 43 makes with respect to the film at its two surfaces are not equal to each other, i.e. θ₁≠θ₂.In these configurations, the base film 44 is optically negative in the direction normal to the film. These base films can be uniaxial films with indices satisfying nₓ=n_{y}>n_{z} such as the one represented by the ellipsoid of index 19 in FIG. 3A or films with small biaxiality nₓ>n_{y}>n_{z} and nₓ−n_{y}<<n_{z}. The compensation film is placed between polarizer 68 and liquid crystal cell 45, for example, as shown in FIG. 7A and 7B or 7C. In 7A and 7B, it is the base film side that is in contact with the polarizer 68. In 7A, the optic axis 42 is tilted toward the transmission axis 70 of the adjacent polarizer 68 while the optic axis 42 tilt is perpendicular to it in 7B. Positive birefringent layer side 64 is in contact with the polarizer 68 in 7C. The plane containing the optic axis 42 and the film normal is parallel to the transmission axis of polarizer. Compensation films in configuration 7A, 7B, and 7C have different optical characteristics.

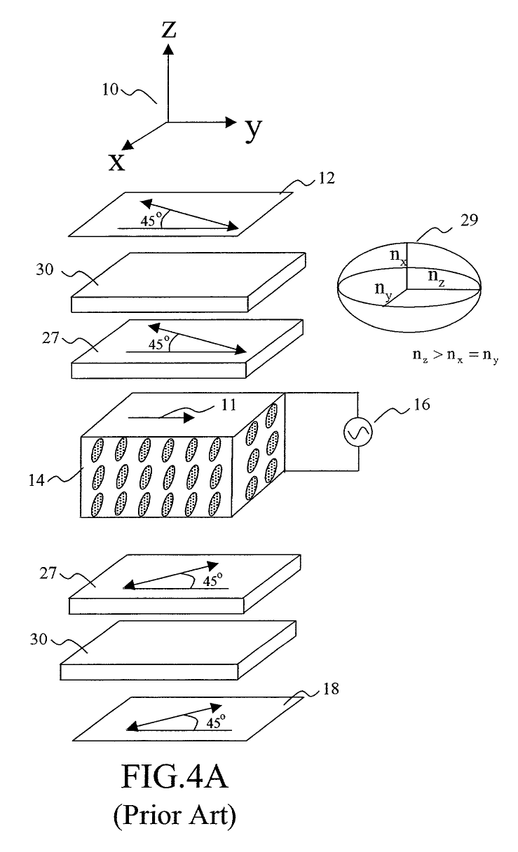

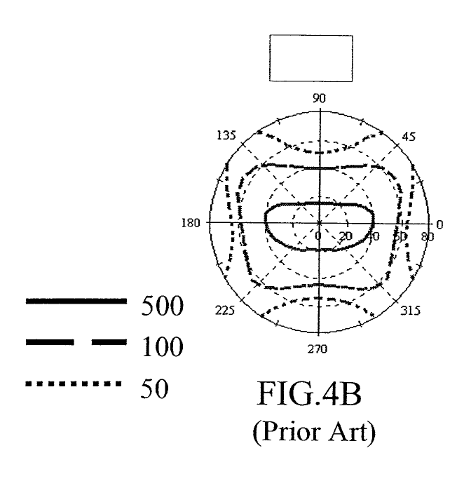

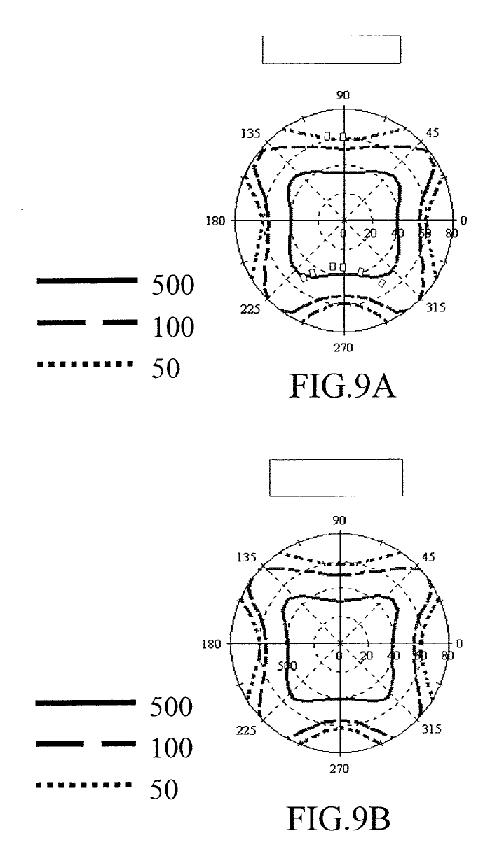

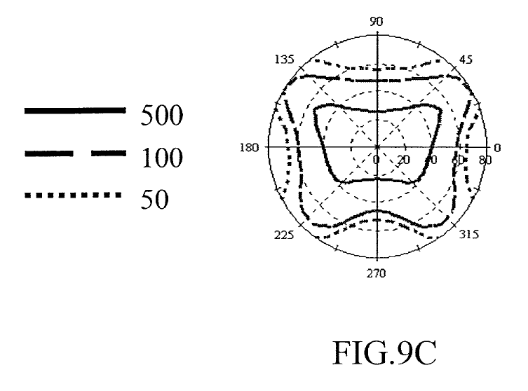

It has been realized in this invention that the uniform tilt or continuous tilt of the optic axis inside of the positive bireflingent layer, represented by 6B and 6C, gives a superior viewing angle as demonstrated by FIG. 9A and 9B in comparison to the prior art shown in FIG. 3B and FIG. 4B. In the prior art U.S. Pat. No. 6,141,075, the optic axis in the compensation films is either parallel or perpendicular to the film plane. For this simulation, cell thickness is fixed at 4.2 micron and liquid crystal MLC6048 from Merck Inc. is used. The placement of compensation film is according to FIG. 7A. The tilted structures, 46 and 50 give broader area with a high contrast ratio. In FIG. 9A and 9B, the 100 iso-contrast line now extends more in the vertical direction up to ±55 degree. The 500 line has been expanded to ±35 to 40 degree also in the vertical direction giving more symmetric shape compared with FIG. 4B. Current inventors also found other placement of positive and negative birefringent plates such as given in FIG. 7B and 7C have the compensating function.

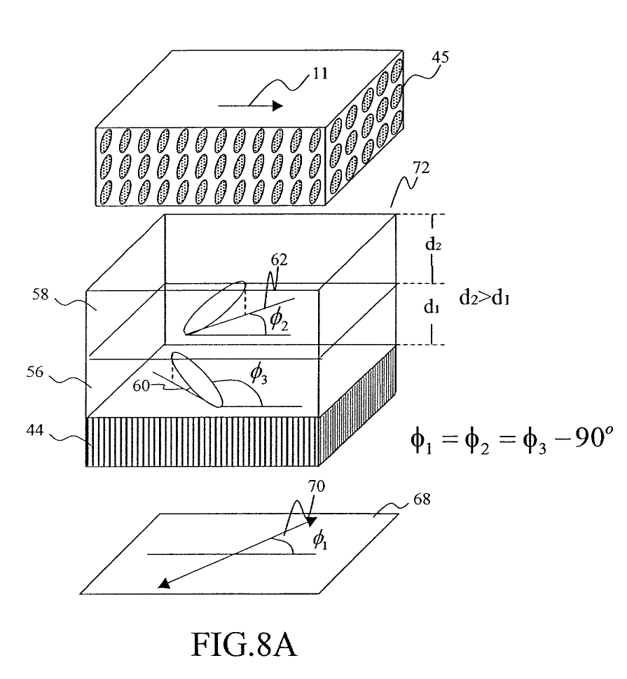

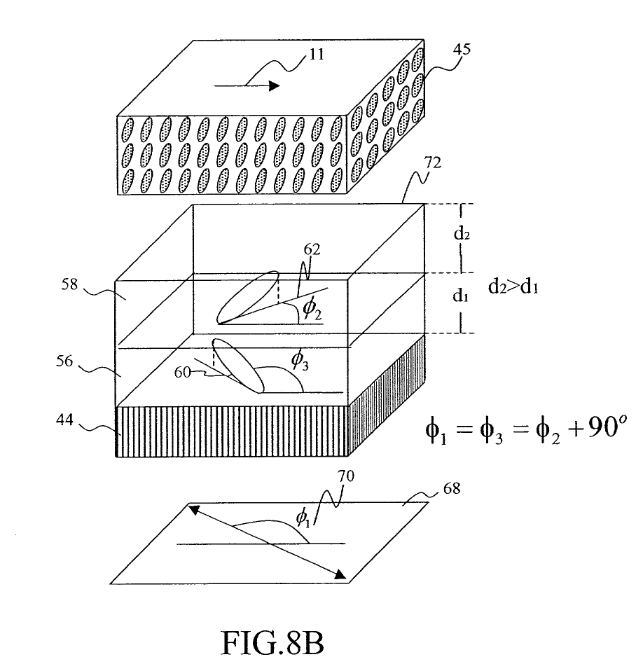

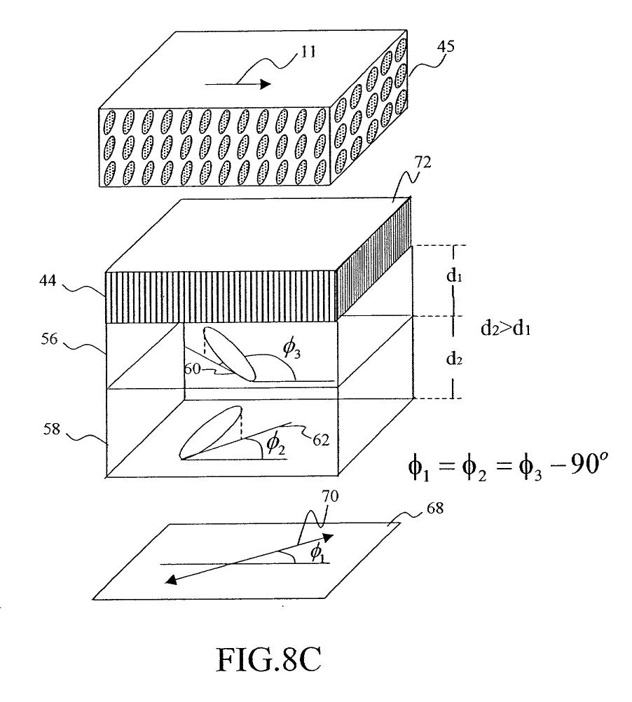

The compensation layers of FIG. 6D contain two positive birefringent layers 56 and 58 with a different thickness disposed on the base film 44. The film plane projection of optic axis in two layers 60 and 62 are orthogonal to each other. In this case, the base 44 may or may not have a negative birefringence in the film normal direction. FIG. 8A, 8B and 8C illustrate the three examples of placement of this type of compensation film 72 with respect to the adjacent polarizer 68. In 8A, the azimuth 42 of the thicker layer 58 is equal to the azimuth φ₁ of transmission axis 70 of polarizer 68, and the azimuth φ₃ of the thinner layer 56 is equal to 90+φ₂. The thinner layer 56 is closer to the polarizers 68 than the thicker layer 58. In 8B, azimuth φ₂ is perpendicular to that of thinner layer φ₃ and polarizer's transmission axis φ₁. Azimuths φ₁ and φ₃ are equal. The thinner layer 56 side is facing to the polarizer 70. In 8C, positive birefringent layer 58 is in contact with the adjacent polarizer 68. Here the azimuth φ₁ is parallel to that of the thicker layer 58 φ₂. The azimuth φ₃ of the thinner layer 56 satisfies φ₃=φ₁+90°.

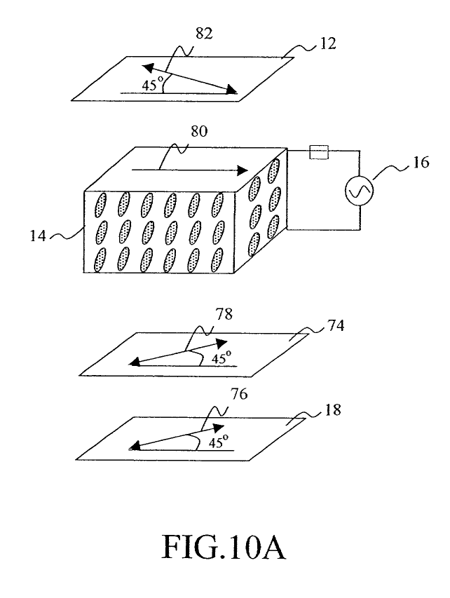

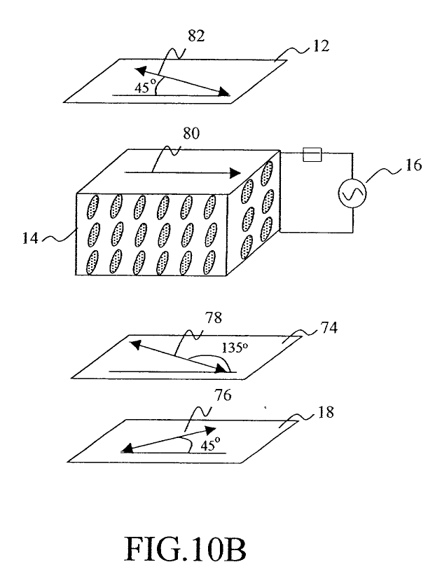

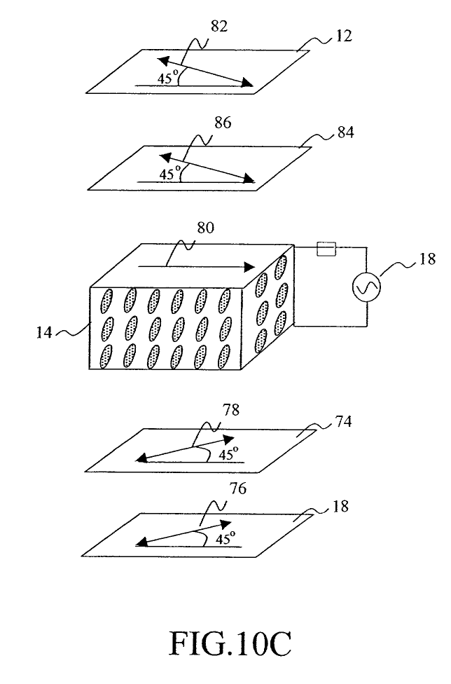

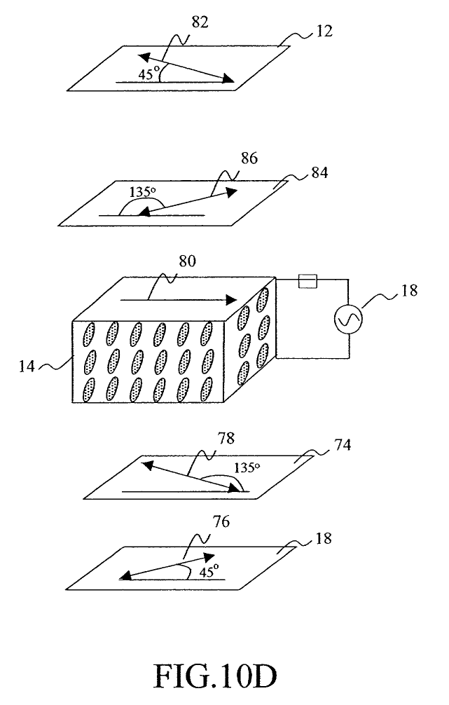

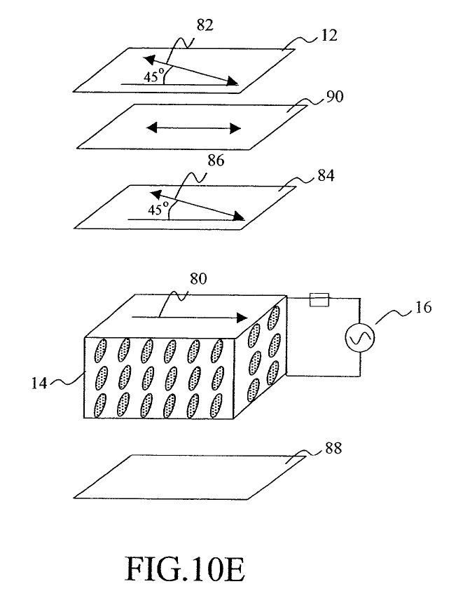

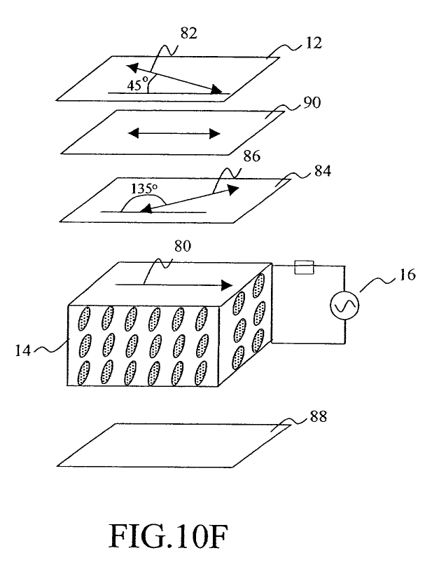

FIG. 10A through 10F show the overall schematic diagram of one embodiment according to the invention. Configuration 10A has one compensation film 74 on one side of the liquid crystal cell 14. A pair of polarizers 12 and 18, are disposed on opposite sides of the vertically aligned liquid crystal cell. Their transmission axes (polarization axes) 82 and 76 are orthogonally crossed with respect to each other in a direction normal to the cell surface, and form a 45 degree angle with respect to the tilt direction of liquid crystal molecules 80. For a film with one positive birefringent layer, a projection 66 of optic axis 42 in positive birefringent layer 64 of FIG. 7A and 7C correspond to the direction specified by 78 in FIG. 10A. FIG. 10B is a diagram for the configuration given in FIG. 7B. The direction 78 is now perpendicular to 76. In case of a compensation film with two positive birefringent layers disposed on the base film, it is a projection of the optic axis 62 of thicker layer 58 in FIG. 8A, 8B and 8C that correspond to 78. FIG. 10C and 10D are configuration with two compensation films 74 and 84. 84 has a direction 86 indicating the direction equivalent to 66 for single and 62 for two positive birefringent layer compensation film. The principle of placement is the same as the one compensation film case, FIG. 10A and 10B. FIG. 10E and FIG. 10F show the vertically aligned liquid crystal cell disposed between the polarizer and a reflective plate, with the compensation film disposed between the vertically aligned cell and the polarizer. 88 is a reflective plate, such as mirror. One compensation film 84 is inserted between the liquid crystal cell 14 and the polarizer 12. Also, additional plate 90 with in-plane phase retardation is placed. The direction 86 is paralell (FIG. 10E) or perpendicular (FIG. 10F) to 82.

The compensation film in accordance with the present invention can be produced by various methods. One example is a photo-alignment method as it was suggested by Schadt et al. (Japanese Journal of Applied Physics, Part 2 (Letters) v 34 n 6 1995 pp.L764-767). For example, a thin alignment layer is coated on the base film followed by radiation of polarized light. Liquid crystal monomer is then coated on the alignment layer and polymerized by further radiation. The tilt of optic axis in positive bireftingent film depends on the radiation angle, thickness of anisotropic layers as well as properties of materials. Also, desired alignment can be obtained by mechanically rubbed surface of alignment layer. Other known methods employ shear orientation and the effect of an electric or magnetic field.

In the following, preferable optical properties of optical compensation film such as thickness and optic axis tilt are given. The positive phase retardation from the liquid crystal cell in the OFF state ΔR, is approximately,

ΔR=(nₑ−nₒ)d_{c}, (1)

where nₑ and nₒ are the extraordinary and ordinary index of refraction for liquid crystal. d_{c} is the thickness of the cell. A film with −ΔR is needed for compensating the vertically aligned liquid crystal with small tilt angle and without an external field applied. Optimization of crossed polarizers requires combination of in-plane and out of plane phase retardation. In the following, the retardation of the positive birefringent layer according to the present invention is given by ΔRₐ=(n₃−n₁)d, where (n₃−n₁) is the birefringence and d is thickness. Since the positive birefringent material has its optic axis tilted in a plane perpendicular to the liquid crystal cell face, this material contributes both in-plane and out of plane retardation ΔR_{c}. The total out of plane retardation ΔR_{T} provided by the base film depends on ΔR_{c} and ΔR. In configuration given in FIG. 7A, ΔRₐ is preferably between 20 nm<ΔRₐ<50 nm or more preferably, 30 nm<ΔRₐ<40 nm, if two films are placed on both sides of the liquid crystal cell as FIG. 10C. For ΔR_{T}, 0.6ΔR_{c}<ΔR_{T}<0.9ΔR_{c} or more preferably, 0.7ΔR_{c}<ΔR_{T}<0.8ΔR_{c}.

For compensation films 48 and 52 in this invention, the negative retardation ΔR_{T} is from the base film 44 while anisotropic layer 46 and 50 contribute ΔRₐ. In the example 7A, the tilt θ₁ as specified in FIG. 6B, satisfies the relation 10°≦θ₁≦40° or preferably, 20°≦θ₁≦30°. For varying tilt as in FIG. 6C, θ₂ and θ₃ are in the range: 30°≦θ₂≦60°, 0°≦θ₃≦30° or more preferably 40°≦θ₂≦50° and 0°≦θ₃≦10° for the best performance. We can have a reversed tilt change as well. In this case, θ₂ and θ₃ satisfy, 0°≦θ₂≦30° and 30°≦θ₃≦60° or more preferably 0°≦θ₂≦10° and 40°≦θ₃≦50. In 7B and 7C, θ₁ satisfies 3°≦θ₁≦10° or for the best performance 5°≦θ₁≦7°. For varying tilt as in FIG. 6C, θ₂ and θ₃ are in the range specified by 0°≦θ₂≦8°, 6°≦θ₃≦12° or more preferably, 0°≦θ₂≦3°, 7°≦θ₃≦10°. As for the case of 7A, reverse tilt (exchanging θ₂ and θ₃ in the above relation) is also acceptable.

Compensation film 54 is different from 48 and 52. In this case, the crossed positive birefringent layers on the base film contribute both of out of plane ΔR_{T} and in-plane retardation. Therefore, base film 44 may be optically isotropic. The equal thickness portion of two layers has phase retardation ΔR_{T}, and the residual thickness |d₁-d₂| contributes in-plane retardation.

The optically anisotropic compensation film is comprised of at least one positive birefringent layer disposed on a base film. If more than two layers are disposed, they may or may not have an equal thickness. Inside a single positive birefringent layer, the direction of optic axis stays constantly tilted or varies across the thickness. In some cases, the direction changes continuously throughout the thickness in a plane perpendicular to the layer. If there are more than two positive birefringent layers disposed on the base film, the projection of optic axis on the film plane of each layer are orthogonal. The base film may or may not be birefringent.

The invention may be used in conjunction with electronic liquid crystal display devices. The energy required to achieve this control is generally much less than that required for the luminescent materials used in other display types such as cathode ray tubes. Accordingly, LC technology is used for a number of applications, including but not limited to digital watches, calculators, portable computers, electronic games for which light weight, low power consumption and long operating life are important features.

Active-matrix liquid crystal displays (LCDs) use thin film transistors (TFTs) as a switching device for driving each liquid crystal pixel. These LCDs can display higher-definition images without cross talk because the individual liquid crystal pixels can be selectively driven.

Ordinary light from an incandescent bulb or from the sun is randomly polarized, that is, it includes waves that are oriented in all possible directions. A polarizer is a dichroic material that functions to convert a randomly polarized (“unpolarized”) beam of light into a polarized one by selective removal of one of the two perpendicular plane-polarized components from the incident light beam. Linear polarizers are a key component of liquid-crystal display (LCD) devices.

There are several types of high dichroic ratio polarizers possessing sufficient optical performance for use in LCD devices. These polarizers are made of thin sheets of materials, which transmit one polarization component and absorb the other mutually orthogonal component (this effect is known as dichroism). The most commonly used plastic sheet polarizers are composed of a thin, uniaxially-stretched polyvinyl alcohol (PVA) film, which aligns the PVA polymer chains in a more-or-less parallel fashion. The aligned PVA is then doped with iodine molecules or a combination of colored dichroic dyes (see, for example, EP 0 182 632 A2, Sumitomo Chemical Company, Limited), which adsorb to and become uniaxially oriented by the PVA to produce a highly anisotropic matrix with a neutral gray coloration. To mechanically support the fragile PVA film it is then laminated on both sides with stiff layers of triacetyl cellulose (TAC), or similar support.

Contrast, color reproduction, and stable gray scale intensities are important quality attributes for electronic displays, which employ liquid crystal technology. The primary factor limiting the contrast of a liquid crystal display is the propensity for light to “leak” through liquid crystal elements or cell, which are in the dark or “black” pixel state. Furthermore, the leakage and hence contrast of a liquid crystal display are also dependent on the angle from which the display screen is viewed. Typically the optimum contrast is observed only within a narrow viewing angle centered about the normal incidence to the display and falls off rapidly as the viewing angle is increased. In color displays, the leakage problem not only degrades the contrast but also causes color or hue shifts with an associated degradation of color reproduction. In addition to black-state light leakage, the narrow viewing angle problem in typical twisted nematic liquid crystal displays is exacerbated by a shift in the brightness-voltage curve as a function of viewing angle because of the optical anisotropy of the liquid crystal material.

In the following examples, liquid crystal MLC6048 from Merck Inc. is used. The cell thickness is 4.2 micron, which makes ΔR=328 nm. Pre-tilt at the boundaries in OFF state is 3° measured from the cell normal direction.

### EXAMPLE 1

The compensation film 48 in FIG. 6B has θ₁=20°. The retardation ΔRₐ from the positive birefringent material and retardation ΔR_{T} from the base are 47 nm and −130 nm, respectively. The film is positioned as shown in FIG. 7A with respect to the polarizer. Two compensation films are used following the configuration given in FIG. 10C. The VAC is given in FIG. 9A in terms of an iso-contrast plot.

### EXAMPLE 2

The compensation film 48 in FIG. 6C with θ₂=40° and θ₃=0°.ΔRₐ and ΔR_{T} are 47 nm and −130 nm, respectively. The film is positioned as shown in FIG. 7A with respect to the polarizer. Two compensation films are used following the configuration given in FIG. l0C. The VAC is given in FIG. 9B in terms of an isocontrast plot.

### EXAMPLE 3

The compensation film 54 according to FIG. 6D, where with θ₁=5°. The film is positioned according to FIG. 8C. The base layer is optically isotropic and does not have phase retardation. The layer d₁ has phase retardation of 180 nm and d₂ has 70 nm. Two compensation films are used following the configuration in FIG. 10C. The VAC is given in FIG. 9D.

The entire contents of the patents and other publications referred to in this specification are incorporated herein by reference.

### Parts List

10 xyz coordinate system

11 tilt direction of liquid crystal molecules

12 polarizer

14 vertically aligned liquid crystal cell

16 voltage source

18 polarizer

19 ellipsoid of index representing optical properties of plate 30

20 cell substrate

22 optic axis in almost vertical direction

24 optic axis tilted

26 light propagating in the vertical direction

27 compensation film with in-plane phase retardation

28 light propagating in the oblique direction

29 ellipsoid of index representing optical properties of plate 27

30 compensation film with out of plane negative phase retardation

31 cross sectional view of the device with one compensation film according to the invention.

32 polarizer

33 light reflecting plate

34 liquid crystal cell

35 cross sectional view of the device with two compensation films according to the invention

36 compensation film

37 cross sectional view of the reflection type device according to the invention

38 polarizer

40 compensation film

42 index of ellipsoid representing optical properties of constituent material of positive birefringent layer

43 optic axis

44 base film of compensation film

45 liquid crystal cell

46 optically positive birefringent layer with uniform tilt in optic axis

48 compensation film with uniform tilt layer 46

50 optically positive birefiingent layer with varying tilt in optic axis

52 compensation film with varying tilt layer 50

54 compensation film with two positive birefringent layers 56 and 58 on the base film 44

56 positive birefringent layer in contact with the base film 44

58 top positive bireflingent layer

60 projection of optic axis of the layer 58

62 projection of optic axis of the layer 56

64 anisotropic layer with positive birefringence

66 projection of optic axis 42

68 polarizer

70 direction of transmission axis of the polarizer 68

72 compensation film with two positive birefringent layers 56 and 58 on the base film 44

74 compensation film

76 transmission axis of polarizer 18

78 direction of in-plane phase retardation of the compensation film 74

80 tilt direction of liquid crystal molecule

82 transmission axis of polarizer 12

84 compensation film

86 direction of in-plane phase retardation of the compensation film 84

88 reflection plate

90 plate with in-plane retardation in the direction of 80

What is claimed is:

1. An imaging component comprising a vertically aligned nematic liquid crystal cell, a polarizer, and a compensation film containing a positive birefingent material oriented with its optic axis tilted in a plane perpendicular to the liquid crystal cell face.

2. A component according to claim 1, comprising a pair of polarizers disposed on opposite sides of the vertically aligned liquid crystal cell, the polarizers having polarization axes orthogonally crossed with respect to each other in a direction normal to the cell surface.

3. A component according to claim 1 wherein the compensation film is disposed between the liquid crystal cell and the polarizer.

4. A component according to claim 1 wherein the compensation film comprises a positive birefmgent material disposed on a base film that has negative optical anisotropy with an axis along the normal of the substrate

5. A component according to claim 1 wherein the compensation film comprises a first positive bireflingent material disposed on a base film and a second positive birefringent material disposed on the said first positive birefringent material.

6. A component according to claim 5 wherein two positive birefringent material layers have different thickness.

7. A component according to claim 5 wherein tilt in the optic axis of at least one of positive birefringent material layers is uniform.

8. A component according to claim 5 wherein tilt in the optic axis of at least one of positive birefringent material layer varies.

9. A component according to claim 5 comprising an alignment layer between the first positive birefringent layer and the base film.

10. A component according to claim 2 wherein the compensation film is disposed between the vertically aligned liquid crystal cell and one of the polarizers.

11. A component according to claim 9 wherein there is a compensation disposed on each side of the liquid crystal cell between the cell and each of the polarizers.

12. A component according to claim 9 comprising two compensation films disposed between the said vertically aligned liquid crystal cell and one of said polarizers.

13. A component according to claim 1 wherein the tilt in the optic axis of the compensation film is uniform.

14. A component according to claim 1 wherein the tilt in the optic axis of the compensation film varies.

15. The component according to claim 1, wherein the vertically aligned liquid crystal cell is disposed between the polarizer and a reflective plate, and the compensation film is disposed between the vertically aligned cell and the polarizer.

16. The component according to claim 15 wherein the compensation film is disposed on a base film and wherein the tilt in the optic axis thereof is uniform.

17. The component according to claim 15 wherein the compensation film is disposed on a base film and wherein the tilt in the optic axis thereof varies.

18. The component according to claim 15 wherein there are two positive birefringent material layers disposed on a base film and wherein the tilt in the optic axis in at least one of the said layers thereof is uniform.

19. The component according to claim 15 wherein there are two positive birefringent material layers disposed on a base film and wherein the tilt in the optic axis in at least one of the said layers thereof varies.

20. An electronic imaging device containing the component of claim 1.

21. A method of forming a component of claim 1 wherein the orientation of the compensation film is accomplished using photo-alignment.

22. A method of forming a component of claim 1 wherein the orientation of the compensation film is accomplished using mechanical rubbing.

23. A method of forming a component of claim 1 wherein the orientation of the compensation film is accomplished using shear forces.

24. A method of forming a component of claim 1 wherein the orientation of the compensation film is accomplished using electric or magnetic field effects.
